(19) United States
(12) Patent Application Publication
(10) Pub. No.: US 2020/0233384 A1
(43) Pub. Date: Jul. 23, 2020

(54) REINFORCEMENT LEARNING METHOD, RECORDING MEDIUM, AND REINFORCEMENT LEARNING APPARATUS

(71) Applicant: FUJITSU LIMITED, Kawasaki-shi (JP)

(72) Inventor: Hidenao Iwane, Kawasaki (JP)

(73) Assignee: FUJITSU LIMITED, Kawasaki-shi (JP)

(21) Appl. No.: 16/733,880

(22) Filed: Jan. 3, 2020

(30) Foreign Application Priority Data
Jan. 18, 2019 (JP) 2019-006968

(51) Int. Cl. G05B 13/02; G06N 20/00; G05B 19/042

(52) U.S. Cl. CPC G05B 13/0265; G05B 2219/2619; G05B 19/042; G06N 20/00

(57) ABSTRACT

A reinforcement learning method is executed by a computer, for wind power generator control. The reinforcement learning method includes obtaining, as an action for one step in a reinforcement learning, a series of control inputs to a windmill including control inputs for plural steps ahead; obtaining, as a reward for one step in the reinforcement learning, a series of generated power amounts including generated power amounts for the plural steps ahead and indicating power generated by a wind power generator in response to rotations of the windmill; and implementing reinforcement learning for each step of determining a control input to be given to the windmill based on the series of control inputs and the series of generated power amounts.

### CROSS REFERENCE TO RELATED APPLICATIONS

This application is based upon and claims the benefit of priority of the prior Japanese Patent Application No. 2019-006968, filed on Jan. 18, 2019, the entire contents of which are incorporated herein by reference.

### FIELD

The embodiment discussed herein related to a reinforcement learning method, a recording medium, and reinforcement learning apparatus.

### BACKGROUND

Conventionally, in the field of reinforcement learning, for example, an environment is controlled by repeatedly performing a series of process learned by a controller for determining a policy judged to be optimal as an action to the environment, based on a reward observed from the environment in response to the action performed to the environment.

As prior art, for example, there is a technique of building an emotion transition model of a user by reinforcement learning. Further, for example, there is a technique of learning a quality function and activity selection rules based on training data that includes states, activities, and continuous states. Further, for example, there is a technique of controlling a thermal power plant. Further, for example, there is a technique of utilizing intake characteristics for controlling periodic motion of moving parts. Further, for example, there is a technique of updating an interaction parameter so that comfort/discomfort of the interaction parameter is optimized by interpersonal distance and orientation of human subject faces. For examples, refer to Japanese Laid-Open Patent Publication No. 2005-238422, Japanese Laid-Open Patent Publication No. 2011-060290, Japanese Laid-Open Patent Publication No. 2008-249187, Japanese Laid-Open Patent Publication No. 2006-289602, and Japanese Laid-Open Patent Publication No. 2006-247780.

### SUMMARY

According to one embodiment, a reinforcement learning method is executed by a computer, for wind power generator control. The reinforcement learning method includes obtaining, as an action for one step in a reinforcement learning, a series of control inputs to a windmill including control inputs for plural steps ahead; obtaining, as a reward for one step in the reinforcement learning, a series of generated power amounts including generated power amounts for the plural steps ahead and indicating power generated by a wind power generator in response to rotations of the windmill; and implementing reinforcement learning for each step of determining a control input to be given to the windmill based on the series of control inputs and the series of generated power amounts.

An object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram of one example of a reinforcement learning method according to an embodiment,

FIG. 2 is a block diagram of an example of hardware configuration of a reinforcement learning apparatus 100.

FIG. 3 is a diagram depicting an example of storage contents of a history table 300.

FIG. 4 is a block diagram of an example of a functional configuration of the reinforcement learning apparatus 100.

FIG. 5 is a diagram depicting a first operation example of the reinforcement learning apparatus 100.

FIG. 6 is a diagram depicting an example of a specific environment 110.

FIG. 7 is a diagram depicting an example of a specific environment 110.

FIG. 8 is a diagram depicting an example of a specific environment 110.

FIG. 9 is a diagram depicting an example of a specific environment 110.

FIG. 10 is a diagram depicting an example of a specific environment 110.

FIG. 11 is a diagram depicting results obtained by the reinforcement learning apparatus 100.

FIG. 12 is a diagram depicting results obtained by the reinforcement learning apparatus 100.

FIG. 13 is a diagram depicting results obtained by the reinforcement learning apparatus 100.

FIG. 14 is a flowchart of an example of a procedure of a reinforcement learning process.

### DESCRIPTION OF THE INVENTION

First, problems associated with the conventional techniques will be described. In the conventional techniques, the efficiency of learning by reinforcement learning may decrease. For example, when a reward observed immediately after a certain action is performed is large, in the respect that the action increases a gain, the action is judged to be desirable even though unsuitable, thereby falling into a local solution, whereby a controller having good performance may not learn. Thus, gain is a function prescribed by a reward such as a discounted cumulative reward, average reward, etc.

Embodiments of a reinforcement learning method, a reinforcement learning program, and a reinforcement learning apparatus according to the present invention will be described in detail with reference to the accompanying drawings.

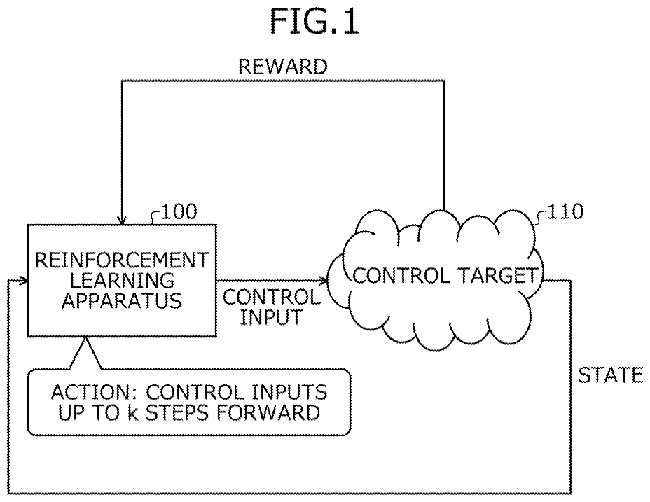

FIG. 1 is a diagram of one example of a reinforcement learning method according to an embodiment. A reinforcement learning apparatus 100 is a computer for controlling an environment 110. The reinforcement learning apparatus 100, for example, is a server or a personal computer (PC), or a microcontroller, etc.

The environment 110 is any event/matter that is a control target and, for example, is a physical system that actually exists. The environment 110, for example, may be on a simulator. In particular, the environment 110 is an automobile, an autonomous mobile robot, an industrial robot, a drone, a helicopter, a server room, a power generator, a chemical plant, or a game, etc.

While model predictive control is an example of a method for controlling the environment 110, in model predictive control, a model is prepared manually and therefore, a problem arises in that the work burden placed on humans increases. Work burden is work cost or work time. Further, in model predictive control, if the prepared model does not correctly express the actual environment 110, a problem arises in that the environment 110 cannot be controlled efficiently and it is further desirable for humans to know the nature of the environment 110.

In contrast, for example, reinforcement learning is a method applicable to the environment 110 as a control method for controlling the environment 110 without manual preparation of a model or humans having to know the nature of the environment 110. In conventional reinforcement learning, for example, to find a controller with better performance than a current controller, an action to the environment 110 is performed and based on a reward observed from the environment 110 in response to the action, the controller learns, whereby the environment 110 is controlled.

Here, in conventional reinforcement learning, the action is defined in units of one control input to the environment 110. The controller is a control law for determining an action. The performance of the controller indicates whether the controller is able to determine for an action, how large contribution to gain is. Gain is prescribed by a discounted cumulative reward or an average reward. A discounted cumulative reward is a total value when a series of rewards over a long period is corrected so that the later a reward occurs in a time series, the smaller is the reward. An average reward is an average value of a series of rewards over a long period. A controller with relatively good performance is able to determine an action that is closer to being an optimal action than is an action determined by a controller with relatively poor performance, and a controller with relatively good performance easily increases gain by the determined action and easily increases the reward. The optimal action, for example, is an action judged to maximize gain in the environment 110. In some cases, it is impossible for humans to know the optimal action,

Nonetheless, with conventional reinforcement learning, the controller cannot learn efficiently. As conventional reinforcement learning, plural variations exist and, in particular, while variations 1 to 3 below exist, for any of these variations, efficient learning by the controller may be difficult.

For example, as variation 1, reinforcement learning may be consider in which an action value function is prepared and the action value function is updated by a Q learning or SARSA update rule, whereby the controller learns. With variation 1, for example, the environment 110 is controlled by repeatedly performing a series of processes including performing an action to the environment 110, updating the action value function based on a reward observed from the environment 110 in response to the action, and updating the controller based on the action value function.

Here, when the action is performed to the environment 110, a specific environment 110 exists that exhibits a nature of increasing a short-term reward from the environment 110 and decreasing a long-term reward or a nature of decreasing a short-term reward from the environment 110 and increasing a long-term reward. For example, when an action is performed that is unsuitable from a perspective of maximizing gain, the specific environment 110 exhibits a nature in which a reward observed immediately after the action is relatively large.

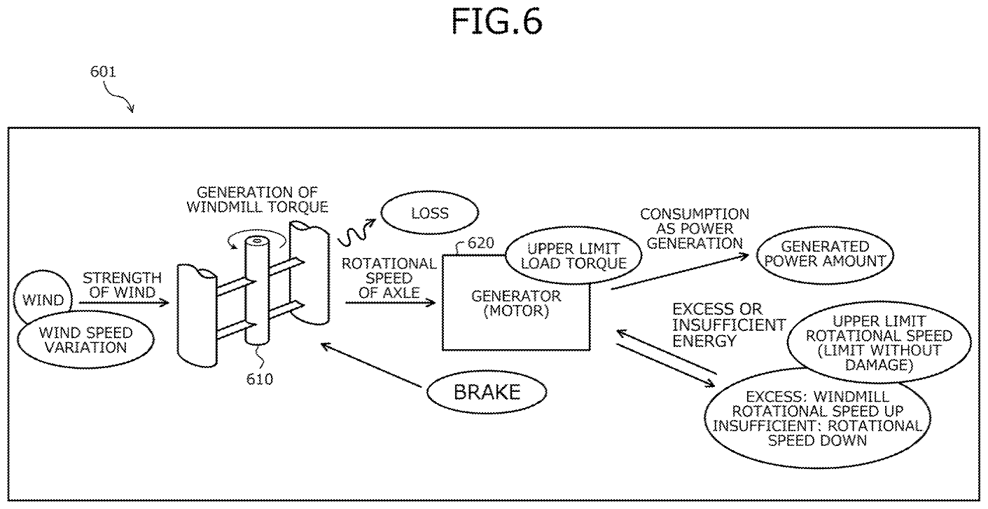

In particular, the specific environment 110 may be considered to be an instance of a windmill related to wind power generation. In this case, the action is control input related to load torque of a power generator connected to the windmill and the reward is a generated power amount of the power generator. In this case, when an action of increasing the load torque is performed, wind power is used to a greater extent in power generation of the power generator than in rotation of the windmill and therefore, while a short-term generated power amount increases, rotational speed of the windmill decreases, whereby a long-term generated power amount decreases. A specific example of the specific environment 110, for example, will be described hereinafter with using FIGS. 6 to 8.

When variation 1 is applied in controlling the specific environment 110, it is difficult to judge whether an action is a suitable action or an unsuitable action from the perspective of maximizing gain and thus, it is difficult to learn a good performance controller.

For example, with variation 1, even when an action is an unsuitable action from the perspective of maximizing gain, if the reward observed immediately after the action is performed is relatively large, the action is easily misjudged to be a suitable action. As a result, with variation 1, what type of action is a suitable action cannot be learned and thus, a good performance controller cannot be learned.

Further, variation 1 defines an action to the environment 110 in units of one control input to the environment 110. Therefore, with variation 1, when learning what types of actions are suitable actions occurs, learning is in units of one control input to the environment 110 and it is impossible to take into consideration how a control input to the environment 110 was changed. As a result, with variation 1, it is difficult to learn a good performance controller.

Further, with variation 1, there is a possibility that a good performance controller can be learned provided that various actions are tried for various states of the environment 110, what types of actions are suitable actions are learned, and a local solution can be escaped from, however, processing time increases. Further, when the environment 110 exists in reality rather than on a simulator, arbitrarily changing a state of the environment 110 is difficult and with variation 1, it is difficult to try various actions for various states of the environment 110 and thus, it is difficult to learn a good performance controller.

As variation 2, reinforcement learning may be considered in which a controller learns based on a state of the environment 110, an action to the environment 110, or a reward, etc. from the environment 110 at each time point among plural past time points. Variation 2, in particular, is reinforcement learning based on Sasaki, Tomotake, et al, “Derivation of integrated state equation for combined outputs-inputs vector of discrete-time linear time-invariant system and its application to reinforcement learning.” Society of Instrument and Control Engineers of Japan (SICE), 2017 56th Annual Conference of the IEEE, 2017.

When variation 2 is applied in controlling the specific environment 110, it is difficult to judge whether an action is a suitable action or an unsuitable action from the perspective of maximizing gain and thus, it is difficult to learn a good performance controller. For example, with variation 2 as well, even when an action is an unsuitable action, if the reward observed immediately after the action is performed is relatively large, the action is easily misjudged to be a suitable action. Further, variation 2 also defines an action to the environment 110 in units of one control input to the environment 110 and therefore, when learning what types of actions are suitable actions occurs, learning is in units of one control input to the environment 110 and it is impossible to take into consider how a control input to the environment 110 was changed.

As variation 3, reinforcement learning may be considered in which adaptive trace (eligibility trace) is utilized.. Reinforcement learning that utilizes adaptive trace may be an on-policy type or an off-policy type. Variation 3, in particular, is reinforcement learning based on Richard S. Sutton and Andrew G. Barto, “Reinforcement learning: An introduction,” MIT Press, 2012; and JING PENG and RONALD J. WILLIAMS, “Incremental Multi-Step Q-Learning,” Machine Learning 22 (1996): 283-290.

When variation 3 is an off-policy type, importance sampling is utilized, and sampling of only greedy actions judged to be optimal by the controller at this time is utilized. Therefore, when variation 3 is applied in controlling the specific environment 110 above, it is difficult to judge whether an action is suitable or unsuitable and therefore, it is difficult to learn a good performance controller.

Thus, in the present embodiment, a reinforcement learning method is described that by defining a series of control inputs to the environment 110 as an action in reinforcement learning, enables a good performance controller to be learned easily without bias of only changes in short-term reward.

In FIG. 1, the reinforcement learning apparatus 100 implements reinforcement learning based on a series of control inputs to the environment 110 including control inputs plural steps ahead and a series of rewards from the environment 110 in response to the series of control inputs to the environment 110 including the control inputs plural steps ahead. Here, the reinforcement learning apparatus 100 utilizes and defines a series of control inputs to the environment 110 including control inputs plural steps ahead as an action in the reinforcement learning.

A step is a process of determining a control input to be given to the environment 110. A step, for example, is a process of determining a series of control inputs to the environment 110 including control inputs plural steps ahead to be an action to the environment 110 and determining as a control input to be given to the environment 110, the first control input of the series of control inputs determined as an action. The reinforcement learning, for example, utilizes Q learning, SARSA, etc.

The reinforcement learning apparatus 100, for example, for each step,. determines and stores a series of control inputs to the environment 110 including control inputs k steps ahead to be an action to the environment 110. In the description hereinafter, “up to k steps ahead” with respect to a given step means plural steps including a first step to a k-th step, where the given step is the first step and k≥2.

The reinforcement learning apparatus 100, for each step, determines and stores as a control input that is to be given to the environment 110, the first control input of the series of control inputs determined as an action. Each time the reinforcement learning apparatus 100 gives a control input to the environment 110, the reinforcement learning apparatus 100 obtains and stores a reward from the environment 110 in response to the control input. The reinforcement learning apparatus 100 updates a controller based on a series of control inputs for k steps actually given to the environment and based on a series of rewards for the k steps obtained in response to the series of control inputs for k steps actually given to the environment.

As a result, the reinforcement learning apparatus 100 may enhance the efficiency of learning by reinforcement learning. The reinforcement learning apparatus 100, for example, considers changes in long-term reward without being influenced only by changes in short-term reward and thereby, may learn the controller. Further, the reinforcement learning apparatus 100, for example, rather than in units of one control input, considers how the control input was changed and thereby, enables the controller to learn. Therefore, the reinforcement learning apparatus 100, for example, enables a good performance controller to be learned even when reinforcement learning is applied in controlling the specific environment 110 above.

Further, the reinforcement learning apparatus 100 is not deceived by the most recent rewards for various states of the environment 110 and is not susceptible to falling into a local solution and thus, may suppress increases in the processing time. The reinforcement learning apparatus 100 further enables reinforcement learning to be applied in controlling the environment 110 that exists in reality rather than on a simulator. The reinforcement learning apparatus 100 enables both on-policy type and off-policy type reinforcement learning to be realized.

Herein, while a case in which reinforcement learning utilizes Q learning, SARSA, etc. has been described, without limitation hereto, for example, the reinforcement learning may utilize a scheme other than Q learning and SARSA. Further, while a case has been described in which k is fixed, without limitation hereto, for example, k may vary.

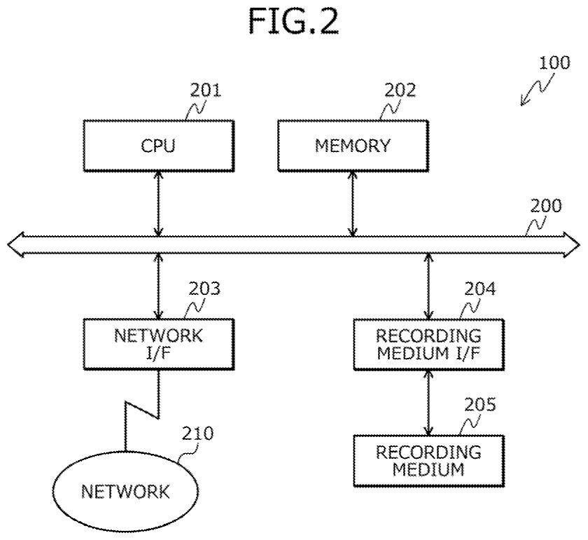

An example of a hardware configuration of the reinforcement learning apparatus 100 will be described using FIG. 2.

FIG. 2 is a block diagram of an example of a hardware configuration of the reinforcement learning apparatus 100. In FIG. 2, the reinforcement learning apparatus 100 has a central processing unit (CPU) 201, a memory 202, a network interface (I/F) 203, a recording medium I/F 204, and a recording medium 205. Further, components are connected by a bus 200.

Here, the CPU 201 governs overall control of the reinforcement learning apparatus 100. The memory 202, for example, has a read only memory (ROM), a random access memory (RAM) and a flash ROM. In particular, for example, the flash ROM and the ROM store various types of programs and the RAM is used as work area of the CPU 201. The programs stored by the memory 202 are loaded onto the CPU 201, whereby encoded processes are executed by the CPU 201.

The network I/F 203 is connected to a network 210 through a communications line and is connected to other computers via the network 210. The network I/F 203 further administers an internal interface with the network 210 and controls the input and output of data with respect to other computers. The network I/F 203, for example, is a modem, a local area network (LAN) adapter, etc.

The recording medium I/F 204, under the control of the CPU 201, controls the reading and writing of data with respect to the recording medium 205. The recording medium I/F 204, for example, is a disk drive, a solid state drive (SSD), a universal serial bus (USB) port, etc. The recording medium 205 is a non-volatile memory storing therein data written thereto under the control of the recording medium I/F 204. The recording medium 205, for example, is a disk, a semiconductor memory, a USB memory, etc. The recording medium 205 may be removable from the reinforcement learning apparatus 100.

In addition to the components above, the reinforcement learning apparatus 100, for example, may have a keyboard, a mouse, a display, a printer, a scanner, a microphone, a speaker, etc. Further, the reinforcement learning apparatus 100 may have the recording medium I/F 204 and/or the recording medium 205 in plural. Further, the reinforcement learning apparatus 100 may omit the recording medium I/F 204 and/or the recording medium 205.

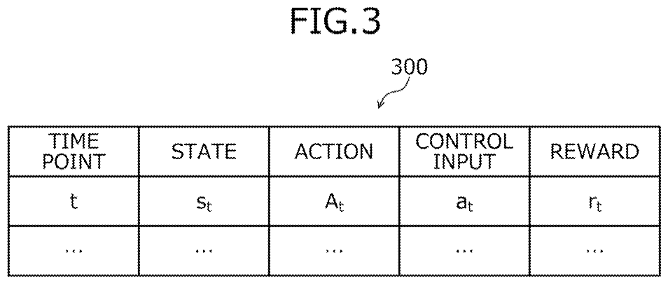

Storage contents of a history table 300 will be described using FIG. 3. The history table 300, for example, is realized by a storage area the memory 202 or the recording medium 205, etc. of the reinforcement learning apparatus 100 depicted in FIG. 2.

FIG. 3 is a diagram depicting an example of storage contents of the history table 300. As depicted in. FIG. 3, the history table 300 has fields for states, actions, control inputs, and rewards corresponding to a field for time points. Information is set into the fields according to time point, whereby history information is stored to the history table 300.

In the time point field, a time point indicated in multiples of a unit time is set. In the state field, a state of the environment 110 at the time point set in the time point field is set. In the action field, as an action to the environment 110 at the time point in the time point field, a series of control inputs up to k steps ahead is set, where a step for the time point set in the time point field is the first step. In the control input field, a control input that is given to the environment 110 at the time point set in the time point field and that is the first control input in the action is set. In the reward field, a reward from the environment 110 at the time point set in the time point field is set.

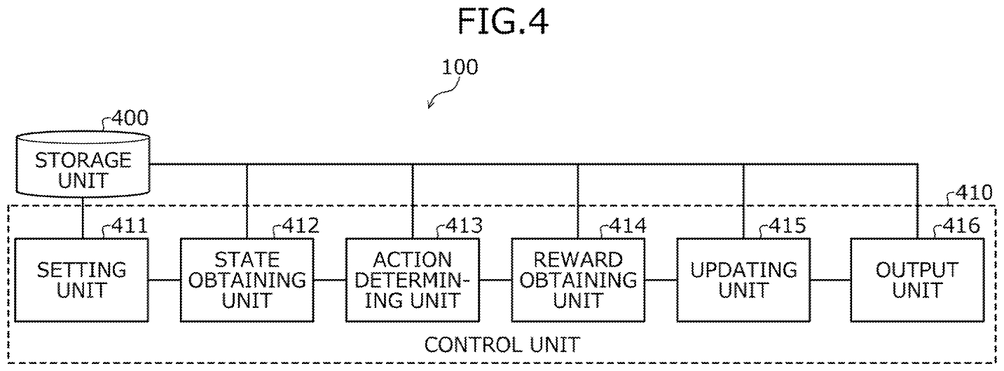

An example of a functional configuration of the reinforcement learning apparatus 100 will be described using FIG. 4.

FIG. 4 is a block diagram of an example of a functional configuration of the reinforcement learning apparatus 100. The reinforcement learning apparatus 100 includes a storage unit 400, a setting unit 411, a state obtaining unit 412, an action determining unit 413, a reward obtaining unit 414, an updating unit 415, and an output unit 416.

The storage unit 400, for example, is realized by a storage area of the memory 202 or the recording medium 205 depicted in FIG. 2. Hereinafter, while a case will be described in which the storage unit 400 is included in the reinforcement learning apparatus 100, without limitation hereto, for example, the storage unit 400 may be included in an apparatus different from the reinforcement learning apparatus 100, and the storage contents of the storage unit 400 may be referred to from the reinforcement learning apparatus 100.

The setting unit 411 to the output unit 416 function as one example of a control unit 410. Functions of the setting unit 411 to the output unit 416, in particular, for example, are realized by executing on the CPU 201, programs stored in a storage area of the memory 202 or the recording medium 205 depicted in FIG. 2 or by the network I/F 203. Process results of the functional units, for example, are stored to a storage area of the memory 202 or the recording medium 205 depicted in FIG. 2.

In processes of the functional units, the storage unit 400 is referred to or various types of updated information is stored thereto, The storage unit 400 accumulates actions to the environment 110, control inputs given to the environment 110, states of the environment 110, and rewards from the environment 110. An action is a series of control inputs including those plural steps ahead. A control input, for example, is a command value given to the environment 110. The control input, for example, is a real value that is a continuous quantity. The control input, for example, may be a discrete value, The storage unit 400, for example, uses the history table 300 depicted in FIG. 3 to store according to time point, actions to the environment 110, control inputs given to the environment 110, states of the environment 110, and rewards from the environment 110.

The environment 110, for example, may be a power generating facility. A power generating facility, for example, is a wind-power power generating facility. In this case, the control input, for example, is a control mode for power generator torque of the power generating facility. The state, for example, is at least one of the rotational speed [rad/s] of a turbine of the power generating facility, the wind direction with respect to the power generating facility, the wind speed [m/s] with respect to the power generating facility, etc. The reward, for example, is the generated power amount [Wh] of the power generating facility.

Further, the environment 110, for example, may be air conditioning equipment. In this case, the control input, for example, is at least one of the set temperature of the air conditioning equipment, the set air flow of the air conditioning equipment, etc. The state, for example, is at least one of the temperature inside the room having the air conditioning equipment, the temperature outside the room having the air conditioning equipment, the weather, etc. The reward, for example, is a negative value of a power consumption amount of the air conditioning equipment.

Further, the environment 110, for example, may be an industrial robot. In this case, the control input, for example, is the motor torque of the industrial robot. The state, for example, is at least one of an image taken of the industrial robot, the position of a joint of the industrial robot, the angle of the joint of the industrial robot, the angular velocity of the joint of the industrial robot etc. The reward, for example, is production yield of the industrial robot. The production yield, for example, is an assembly count. The assembly count, for example, is the number of products assembled by the industrial robot. Further, the environment 110, for example, may be an automobile, an autonomous mobile robot, a drone, a helicopter, a chemical plant, or a game, etc.

The storage unit 400 stores a reinforcement learner π utilized in reinforcement learning. The reinforcement learner π includes the controller and an updater. The controller is a control law for determining an action for a state of the environment 110. The updater is an update rule for updating the controller. When value function reinforcement learning is implemented, the storage unit 400 stores an action value function utilized by the reinforcement learner π. The action value function is a function that calculates a value of an action.

The value of an action is set to be higher, the larger is a gain from the environment 110 to maximize gain such as a discounted cumulative reward or an average reward from the environment 110. The value of an action, in particular, is a Q value indicating to what extent an action to the environment 110 contributes to reward. The action value function is expressed using a polynomial, etc. When expressed using a polynomial, the action value function is described using variables representing the state and the action. The storage unit 400, for example, stores polynomials expressing action value functions, and coefficients for the polynomials. Thus, the storage unit 400 enables reference to various types of information by processing units.

In the description below, after various processes by the control unit 410 overall are described, the various processes performed respectively by the setting unit 411 to the output unit 416 functioning as one example of the control unit 410 will be described. First, the various processes by the control unit 410 overall are described.

The control unit 410 implements reinforcement learning based on a series of control inputs to the environment 110 including control inputs plural steps ahead and a series of rewards from the environment 110 in response to the series of control inputs to the environment 110 including the control inputs plural steps ahead. Here, the control unit 410 utilizes and defines the series of control inputs to the environment 110 including control inputs plural steps ahead as an action in the reinforcement learning.

A step is a process of determining a control input to give to the environment 11. The step, for example, is a process of determining the series of control inputs to the environment 110 including control inputs plural steps ahead as an action to the environment 110 and determining as a control input to be given to the environment 110, the first control input of the series of control inputs determined as an action, The reinforcement learning, for example, utilizes Q learning, SARSA, etc. The reinforcement learning, for example, is a value function type or a policy gradient type.

The control unit 410, for example, for each step, determines and stores to the history table 300, a series of control inputs to the environment 110 including control inputs plural steps ahead as an action to the environment 110, The control unit 410, for each step, determines as a control input to be given to the environment 110, the first control input of the series of control inputs determined as an action, stores the first control input to the history table 300, and gives the first control input to the environment 110. Each time the control unit 410 gives a control input to the environment 110, the control unit 410 obtains a reward from the environment 110 in response to the control input and stores the reward to the history table 300. Subsequently, the control unit 410 updates the controller based on the series of control inputs actually given to the environment 110 for plural steps and a series of rewards for the plural steps obtained in response to the series of control inputs actually given to the environment 110 for the plural steps.

In particular, the control unit 410, for each step, determines and stores as an action to the environment 110, a series of control inputs to the environment 110 including the control inputs k steps ahead. The control unit 410, for each step, determines, stores, and gives to the environment 110, as a control input to be given to the environment 110, the first control input of the series of control inputs determined as an action. Each time the control unit 410 gives a control input to the environment 110, the control unit 410 obtains a reward from the environment 110 in response to the control input and stores the reward. The control unit 410 updates the controller based on the series of control inputs actually given to the environment for k steps and the series of rewards for the k steps obtained in response to the series of control inputs actually given to the environment 110 for k steps, where k≥2.

In particular, when the control unit 410 is a value-function type reinforcement learner, the reinforcement learning is implemented using a formula that expresses an action value function that prescribes the value of an action. Further, in particular, the control unit 410 may implement the reinforcement learning, using a table that prescribes the value of an action. The reinforcement learning, for example, utilizes Q learning, SARSA etc. Thus, the control unit 410 may enhance the efficiency of learning by reinforcement learning. The control unit 410, for example, considers changes in long-term reward without being influenced only by changes in short-term reward and thereby, may learn the controller. Further, the reinforcement learning apparatus 100, for example, rather than in units of one control input, considers how the control input was changed and thereby, enables the controller to learn.

The various processes performed respectively by the setting unit 411 to the output unit 416 functioning as one example of the control unit 410 will be described.

In the description below, “t” is a symbol representing a time point indicated in multiples of a unit time. “s” is a symbol representing a state of the environment 110 and when representing a state of the environment 110 at a time point t, is expressed with a subscript “t”. Further, “a” is a symbol representing a control input to the environment 110. When explicitly indicating that “a” is a control input to the environment 110 at the time point t, “a” is expressed with a subscript “t”. Further, “A” is a symbol representing an action. When explicitly indicating that “A” is an action to the environment 110 starting from the time point t, is expressed with a subscript “t”. Further, “r” is a symbol representing reward. “r” is a scalar value and when explicitly indicating that “r” is a reward from the environment 110 at the time point t, “r” is expressed with a subscript “t”.

The setting unit 411 sets various types of information such as variables used by the processing units. The setting unit 411, for example, initializes the history table 300. The setting unit 411, for example, sets a variable k based on user operation input. The setting unit 411, for example, sets the reinforcement learner π based on the user operation input. The reinforcement learner π includes the updater and the controller. The reinforcement learner π, for example, includes a function_learn(p) representing the updater and a function_action(s) representing the controller. Thus, the setting unit 411 enables utilization of the variables, etc. by the processing units.

The state obtaining unit 412, for each unit time, obtains a state s of the environment 110 and stores the obtained state s to the storage unit 400. The state obtaining unit 412, for example, for each unit time, obtains a state sₜ of the environment 110 for the current time point t, associates the state sₜ with the time point t, and stores the state sₜ to the history table 300. Thus, the state obtaining unit 412 enables reference to the state s of the environment 110 by the action determining unit 413, the updating unit 415, etc.

The action determining unit 413 determines an action. A, using the reinforcement learner IT and based on the action A, determines a control input a that is actually to be given to the environment 110, and stores the action A and the control input a to the storage unit, 400. In determining the action A, for example, a ϵ greedy algorithm, Boltzmann selection, etc. is utilized The action, for example, is a greedy action or a random action.

The action determining unit 413, for example, uses the reinforcement learner π and determines an action Aₜ based on the state sₜ and stores the action Aₜ to the history table 300. For example, the action. Aₜ is a control input sequence that sequentially includes control inputs aₜ to aₜ₊ₖ₋₁ up to k steps ahead, when a step at the time point t is set as the first step. The action determining unit 413 determines the first control input aₜ of the action Aₜ as the control input aₜ actually given to the environment 110 and stores the first control input aₜ to the history table 300. Thus, the action determining unit 413 determines a desirable control input for the environment 110 and enables efficient control of the environment 110.

The reward obtaining unit 414, each time the control input a is given to the environment 110, obtains a reward r from the environment 110 in response to the control input a and stores the reward r to the storage unit 400. The reward may be a negative value of cost. The reward obtaining unit 414, for example, each time the control input aₜ is given to the environment 110, waits for the elapse of a unit time from when the control input aₜ is given to the environment 110, obtains a reward rₜ₊₁ from the environment 110 at a time point t+1 after the unit time has elapsed, and stores the reward rₜ₊₁ to the history table 300. Thus, the reward obtaining unit 414 enables reference to the reward by the updating unit 415.

The updating unit 415 updates the controller, using the updater of the reinforcement learner π. The updating unit 415, for example, according to Q learning, SARSA, etc., updates the action value function and based on the updated action value function, updates the controller. The updating unit 415, for example, in a case of Q learning, updates the action value function based on the state sₜ, a state sₜ₊ₖ, the action Aₜ=(aₜ, . . . , aₜ₊ₖ₋₁) configured by control inputs from the time t to the time t+k−1, and a reward group Rₜ₊₁; and updates the controller based on the updated action value function. The reward group Rₜ₊₁ includes rewards rₜ₊₁ to rₜ₊ₖ in response to the control inputs aₜ to aₜ₊ₖ₋₁ up to k steps ahead configuring the action Aₜ. Here, “t” differs from “the current time point” when the updater is actually utilized.

Further, the updating unit 415, for example, in a case of SARSA, further updates the action value function based on an action. Aₜ₊ₖ and updates the controller based on the updated action value function. For example, the action Aₜ₊ₖ is a control input sequence that sequentially includes the control inputs aₜ₊ₖ to aₜ₊₂ₖ₋₁ up to k steps ahead, when a step at the time point t+k is set as the first step. Thus, the updating unit 415 may update the controller, enabling the control target to be controlled more efficiently.

The output unit 416 outputs the control input aₜ determined by the action determining unit 413 and gives the control input aₜ to the environment 110. Thus, the output unit 416 enables control of the environment 110. Further, the output unit 416 may output processing results of any of the processing units. Forms of output, for example, are display to a display, print output to a printer, transmission to an external apparatus by the network I/F 203, or storage to a storage area such as the memory 202, the recording medium 205, etc. Thus, the output unit 416 enables notification of the processing results of any of the functional units to a user and enables the convenience of the reinforcement learning apparatus 100 to be enhanced.

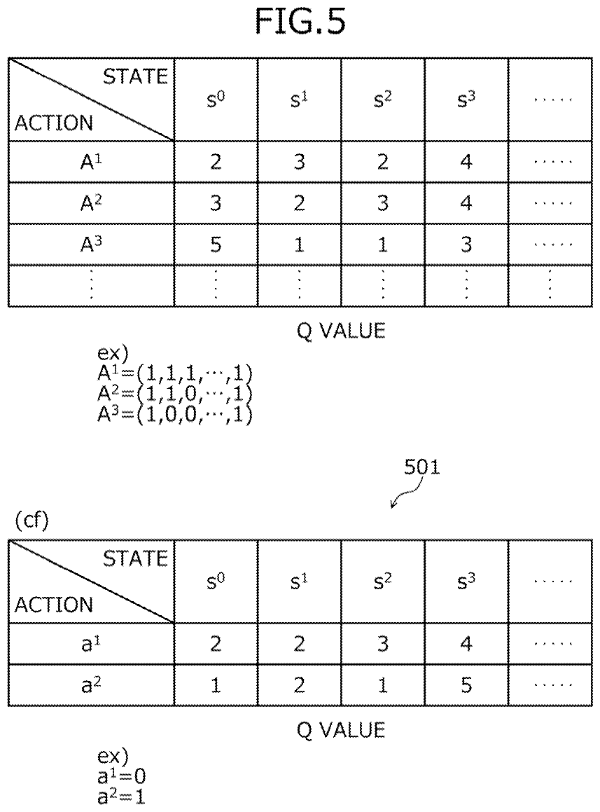

A first operation example of the reinforcement learning apparatus 100 will be described using FIG. 5.

FIG. 5 is a diagram depicting the first operation example of the reinforcement learning apparatus 100. The first operation example is an example in which the reinforcement learning apparatus 100 implements the reinforcement learning by Q learning that uses a Q table 500 expressing action values. In the first operation example, the reinforcement learning apparatus 100, by formula (1), defines and utilizes a series of control inputs up to k steps ahead as an action in the reinforcement learning.

Aₜ=(aₜ, aₜ₊₁, . . . , aₜ₊ₖ₋₁) (1)

Further, in the first operation example, the reinforcement learning apparatus 100 stores Q values, using the Q table 500. As depicted in FIG. 5, the Q table 500 has fields for states, actions, and Q values. The state field is an uppermost row of the Q table 500. In the state field, a state of the environment 110 is set. In the state field, for example, an identifier that identifies a state of the environment 110 is set. The identifiers, for example, are s¹ to s³, etc. The action field is a column farthest on the left side of the Q table 500. In the action field, information representing an action to the environment 110 is set. In the action field, for example, an identifier that identifies an action to the environment 110 including a series of control inputs to the environment 110 is set. The identifiers, for example, are A¹ to A³, etc.

An identifier A¹, for example, identifies an action that includes a series of control inputs (1, 1, 1, 1). An identifier A², for example, identifies an action that includes a series of control inputs (1, 1, 0, 1). An identifier A³, for example, identifies an action that includes a series of control inputs (1, 0, 0, . . . , 1). In the Q value field, for the state indicated by the state field, when the action indicated by the action field is performed, a Q value indicating an extent of contribution to a reward is set.

Further, in the first operation example, the reinforcement learning apparatus 100 utilizes the updater defined by formula (2) to update a Q value stored in the Q table 500. The time point tin formula (2) differs from “the current time point” when the updater is actually utilized. Equation (2) utilizes a discounted cumulative reward as gain, where γ in formula (2) is a discount rate. The discount rate is a weight for a future reward.

$$Q ( {s}_{t} , {A}_{t} ) ← Q ( {s}_{t} , {A}_{t} ) + α ( {\sum }_{i = 0}^{k - 1} {γ}^{i} {r}_{t + i + 1} + {max}_{A} Q ( {s}_{t + k} , A ) - Q ( {s}_{t} , {A}_{t} ) ) \qquad ( 2 )$$

Further, in the first operation example, the reinforcement learning apparatus 100 utilizes a ϵ greedy algorithm, Boltzmann selection, etc. to determine an action. The reinforcement learning apparatus 100 determines an action by a ϵ greedy algorithm. The action is a greedy action or a random action. When the action is to be a greedy action, the reinforcement learning apparatus 100 determines the greedy action by formula (3).

$$( {a}_{t} , {a}_{t + 1} , … , {a}_{t + k - 1} ) = arg {max}_{A} Q ( {s}_{t} , A ) \qquad ( 3 )$$

Thus, the reinforcement learning apparatus 100 may realize the reinforcement learning by Q learning that uses the Q table 500. Further, the reinforcement learning apparatus 100 may enhance the efficiency of learning by reinforcement learning. The reinforcement learning apparatus 100, for example, considers changes in long-term reward without being influenced only by changes in short-term reward and thereby, may learn the controller.

Here, in the conventional reinforcement learning, an action to the environment 110 is defined in units of one control input to the environment 110, Therefore, when the conventional reinforcement learning is implemented by Q learning, a Q table 501 is utilized and a Q value is stored in units of one control input. An identifier a¹ identifies a control input 0. An identifier a² identifies a control input 1. Accordingly, the conventional reinforcement learning aggregates a Q value of the control input 0 and a Q value of the control input 1 without distinguishing the series of control inputs identified by the identifiers A¹ to A³.

In contrast, the reinforcement learning apparatus 100 may distinguish the series of control inputs identified by the identifiers A¹ to A³ and update the Q values. Therefore, the reinforcement learning apparatus 100, for example, rather than in units of one control input, considers how the control input was changed and thereby, enables the controller to learn. As a result, the reinforcement learning apparatus 100 may obtain a good performance controller.

A second operation example of the reinforcement learning apparatus 100 will be described. The second operation example is an example in which the reinforcement learning apparatus 100 implements the reinforcement learning by Q learning that uses a function approximator that expresses the action value function. In the second operation example, the reinforcement learning apparatus 100, by formula (1), defines and utilizes a series of control inputs up to k steps ahead as an action in the reinforcement learning.

Further, in the second operation example. the reinforcement learning apparatus 100 utilizes the updater defined by formula (4) to update the function approximator. Here, the function approximator expressing an action value for the action A is a function where θ_{A} is a parameter and the reinforcement learning apparatus 100 updates the function approximator by updating θ_{A} by formula (4). The time point t in formula (4) differs from “the current time point” when the updater is actually utilized. The action Aₜ in formula (4), for example, is a control input sequence that sequentially includes the control inputs aₜ to aₜ₊ₖ₋₁ up to k steps ahead, when a step at the time point t is set as the first step.

$${θ}_{{A}_{t}} ← {θ}_{{A}_{t}} + α ( ( {\sum }_{i = 0}^{k - 1} {γ}^{i} {r}_{t + i + 1} + {max}_{A} {Q}_{A} ( {s}_{t + 1} ; {θ}_{{A}_{t}} ) - {Q}_{{A}_{t}} ( {s}_{t} ; {θ}_{{A}_{t}} ) ) {∇}_{{θ}_{{A}_{t}}} {Q}_{{A}_{t}} ( {s}_{t} ; {θ}_{{A}_{t}} ) \qquad ( 4 )$$

Further, in the second operation example. the reinforcement learning apparatus 100 utilizes a ϵ greedy algorithm, Boltzmann selection, etc. to determine an action. The reinforcement learning apparatus 100 determines an action. When the action is a greedy action, the reinforcement learning apparatus 100 determines the greedy action by formula (3).

Thus, the reinforcement learning apparatus 100 may realize the reinforcement learning by Q learning that uses the function approximator. Further, the reinforcement learning apparatus 100 may enhance the efficiency of learning by reinforcement learning. The reinforcement learning apparatus 100, for example, considers changes in long-term reward without being influenced only by changes in short-term reward and thereby, may learn the controller. Further, the reinforcement learning apparatus 100, for example, rather than in units of one control input, considers how the control input was changed and thereby, enables the controller to learn. As a result, the reinforcement learning apparatus 100 may obtain a good performance controller.

A third operation example of the reinforcement learning apparatus 100 will be described. The third operation example is an example in which the reinforcement learning apparatus 100 implements the reinforcement learning by SARSA that uses the Q table 500 that expresses the action value function. In the third operation example, the reinforcement learning apparatus 100, by formula (1), utilizes and defines a series of control inputs up to k steps ahead as an action in the reinforcement learning.

Further, in the third operation example, the reinforcement learning apparatus 100 stores Q values, using the Q table 500. Further, in the third operation example, the reinforcement learning apparatus 100 utilizes the updater that is defined by formula (5), to update Q values stored in the Q table 500. The time point t in formula (5) differs from “the current time point” when the updater is actually utilized.

$$Q ( {s}_{t} , {A}_{t} ) ← Q ( {s}_{t} , {A}_{t} ) + α ( {\sum }_{i = 0}^{k - 1} {γ}^{i} {r}_{t + i + 1} + Q ( {s}_{t + k} , {A}_{t + k} ) - Q ( {s}_{t} , {A}_{t} ) ) \qquad ( 5 )$$

Further, in the third operation example, the reinforcement earning apparatus 100 utilizes a ϵ greedy algorithm, Boltzmann selection, etc. to determine an action. The reinforcement learning apparatus 100 determines an action by a ϵ greedy algorithm. The action is a greedy action or a random action. When the action is to be a greedy action, the reinforcement learning apparatus 100 determines the greedy action by formula (3).

Thus, the reinforcement learning apparatus 100 may realize reinforcement learning by SARSA. Further, the reinforcement learning apparatus 100 may enhance the efficiency of learning by reinforcement learning. The reinforcement learning apparatus 100, for example, considers changes in long-term reward without being influenced only by changes in short-term reward and thereby, may learn the controller. Further, the reinforcement learning apparatus 100, for example, rather than in units of one control input, considers how the control input was changed and thereby, enables the controller to learn. As a result, the reinforcement learning apparatus 100 may obtain a good performance controller.

A result obtained by the reinforcement learning apparatus 100 will be described using FIGS. 6 to 13. First, using FIGS. 6 to 10, an example of the specific environment 110 will be described when by an action, short-term reward from the environment 110 increases while long-term reward decreases, or short-term reward from the environment 110 decreases while long-term reward increases.

FIGS. 6, 7, 8, g, and 10 are diagrams depicting an example of the specific environment 110. In the example depicted in. FIG. 6, the specific environment 110 is a wind-power power generation system 601. The wind-power power generation system 601 has a windmill 610 and a power generator 620. Wind power from the windmill 610 subjected to wind is converted into windmill torque and transmitted to an axle of the power generator 620. Wind speed of the wind subjected to the windmill 610 may vary according to time. Wind power of the wind subjected to the windmill 610 is converted into windmill torque and conversion loss occurs when converted to windmill torque. Further, the windmill 610 has a brake that suppresses windmill rotation.

The power generator 620 generates power, using the windmill 610. The power generator 620, for example, generates power using windmill torque transmitted to the axle from the windmill 610. In other words, the power generator 620 uses the windmill torque transmitted to the axle to generate power and thereby, enables load torque, which is in a direction opposite to that of the windmill torque generated by wind power, to be applied to the windmill. Further, load torque may be generated by causing the power generator 620 to function as an electric motor. The load torque, for example, is a value from 0 to an upper limit load torque.

When energy supplied to the power generator 620 is in excess, rotational speed of the windmill 610 increases. The rotational speed, for example, is rotation angle per unit time and is angular velocity. A unit of the rotational speed, for example, is rad/s. When the energy supplied to the power generator 620 is insufficient as compared to the energy consumed by the power generator 620, the rotational speed of the windmill 610 decreases.

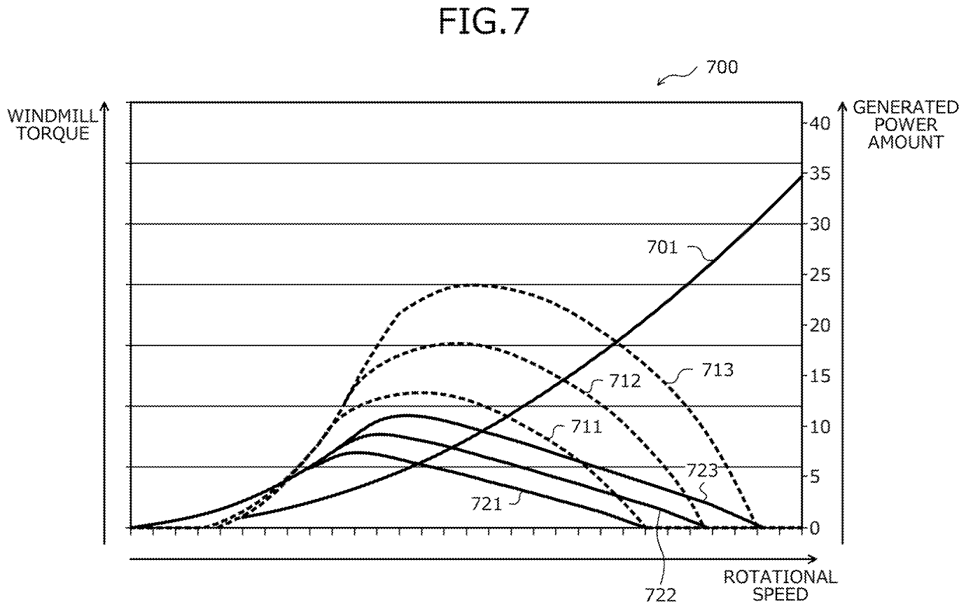

Next, torque characteristics representing a relationship between the windmill torque of the windmill 610 and the rotational speed of the windmill 610 as well as generated power amount characteristics representing a relationship between the windmill torque of the windmill 610 and the generated power amount of the power generator 620 will be described with reference to FIG. 7.

In the example depicted in FIG. 7, torque characteristics of the windmill 610 according to wind speed and generated power amount characteristics according to wind speed are depicted. The torque characteristics of the windmill 610 according to wind speed are curves 721 to 723. The torque characteristics of the windmill 610 are mountain-shape characteristics. The generated power amount characteristics according to wind speed are curves 711 to 713. The generated power amount characteristics are mountain-shape characteristics. A maximum generated power amount point indicating a combination of the rotational speed of the windmill 610 and the windmill torque of the windmill 610 that may maximize the generated power amount of the power generator 620 for a constant wind speed is on curve 701.

Therefore, an operating point of the windmill 610 moving toward a right side of the mountain-shape and approaching the maximum generated power amount point on the right side of the mountain-shape is desirable from a perspective of increasing the generated power amount of the power generator 620. On the other hand, when the wind speed increases and the rotational speed becomes too high, the windmill 610 may become damaged and there may be cases where before the rotational speed becomes too high, movement of the operating point of the windmill 610 to the right side of the mountain-shape is desirable.

Therefore, for example, an efficiency-oriented mode in which the operating point of the windmill 610 approaches the maximum generated power amount point on the right side of the mountain-shape and a speed-suppression mode in which the operating point of the windmill 610 moves to the left side of the mountain-shape may be utilized as control input to the wind-power power generation system 601. In particular, a command value “1” indicating the efficiency-oriented mode and a command value “0” indicating the speed-suppression mode may be utilized as control input to the wind-power power generation system 601.

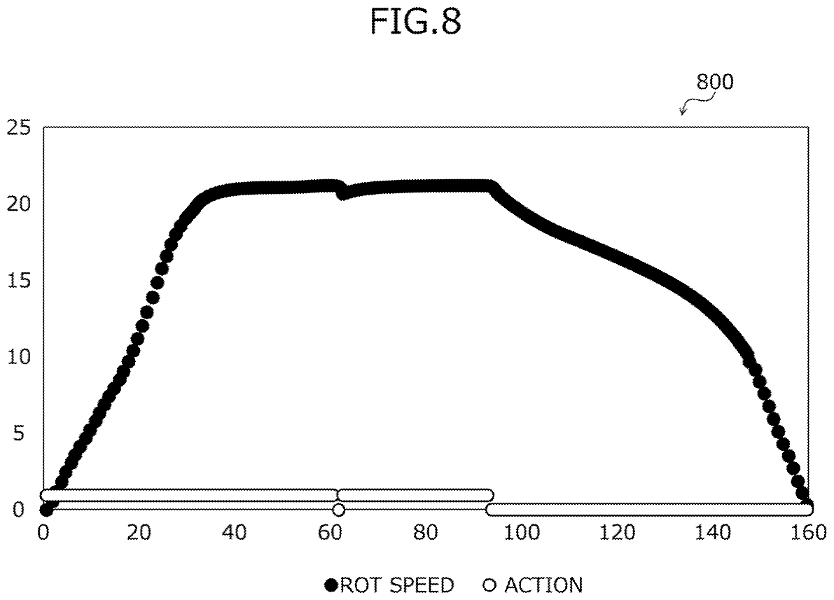

The manner in which the rotational speed of the windmill 610, which is the state, and the generated power amount of the power generator 620, which is the reward change when the control input is changed, will be described using FIGS. 8 to 10 for a case when the control input is set as the command values above. In particular, in the examples depicted in FIGS. 8 to 10, the control input is varied such that from t=0, the control input is set to 1 and maintained until around t=60 when the control input is reset to 0 and again set to 1 and maintained until around t=100 from which the control input is set to 0 and maintained.

A chart 800 depicted in FIG. 8 depicts variation of the rotational speed according to the above changes in the control input. In the chart 800, “∘” indicates control input. In the chart 800, “●” indicates rotational speed. Here, by setting to and maintaining the control input at 1 from t=0, the rotational speed increases and operation occurs at the optimal rotational speed. Next, by resetting the control input to 0 around t=60, the rotational speed decreases. Then, by again setting to and maintaining the control input at 1, the rotational speed recovers. Recovery of the rotational speed takes the time of plural steps. Finally, by setting to and maintaining the control input at 0 from around t=100, the rotational speed becomes 0 and rotation stops.

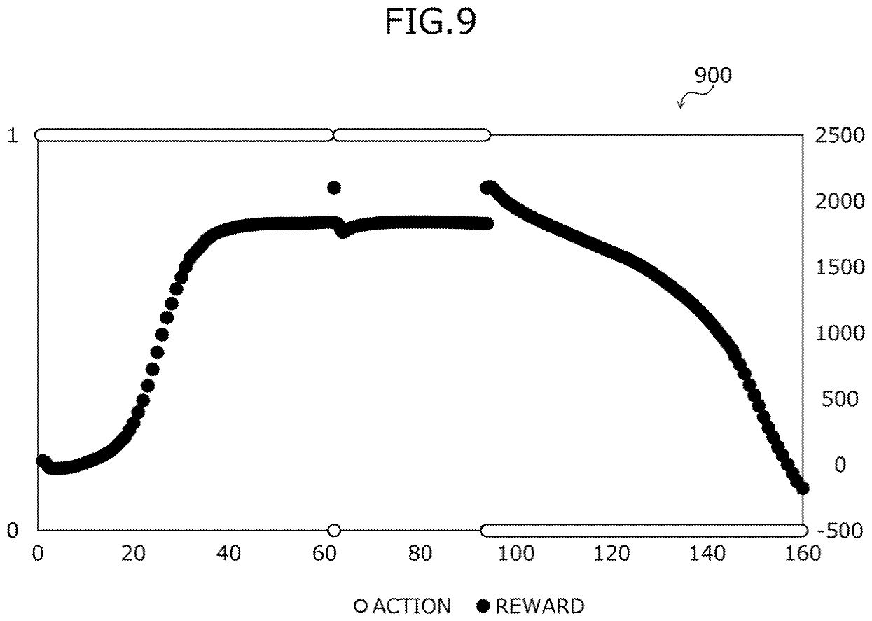

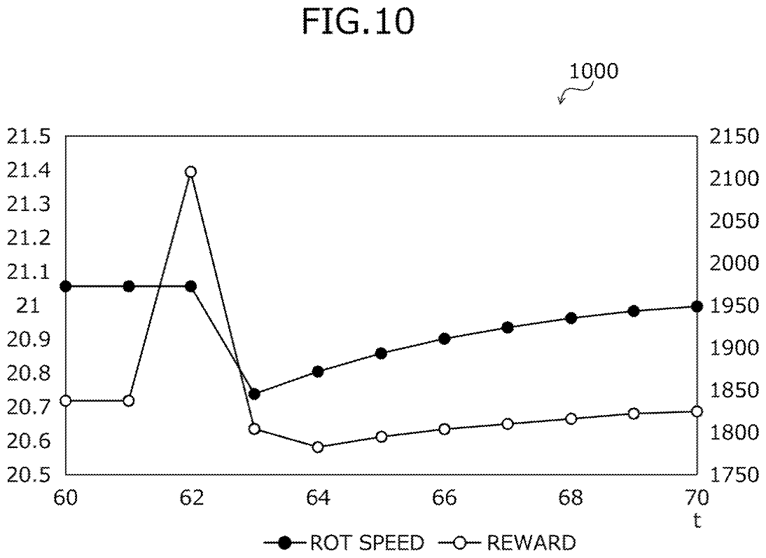

Further, a chart 900 depicted in FIG. 9 depicts variation of generated power amount according to the above changes in the control input. In the chart 900, “∘” indicates control input. In the chart 900, “●” indicates generated power amount. Here, by setting to and maintaining the control input at 1 from t=0, the generated power amount increases. Next, while the generated power amount increases short-term by resetting the control input to 0 around t=60, the generated power amount begins to decrease accompanying the decrease of the rotational speed. Then, by again setting to and maintaining the control input at 1, the generated power amount recovers. Recovery of the generated power amount takes the time of plural steps. Finally, by setting to and maintain the control input at 0 from around t=100, the generated power amount becomes 0. Here, the range t=60 to 70 in the chart 800 and the chart 900 will be described in detail with reference to FIG. 10.

A chart 1000 depicted in FIG. 10 depicts, in detail, variation of the rotational speed and the generated power amount according to the above changes in the control input during the range t=60 to 70. In the chart 1000, “∘” indicates the generated power amount. In the chart 1000, “●” indicates the rotational speed. As depicted in the chart 1000, when the control input is reset to 0, wind power is utilized more for power generation of the power generator than for windmill rotation and the short-term generated power amount increases. On the other hand, as depicted in the chart 1000, the rotational speed of the windmill deceases and the time for the plural steps until the rotational speed of the windmill recovers leads to the generated power amount decreasing and as a result of the generated power amount decreasing, the long-term generated power amount decreases.

Nonetheless, in the conventional reinforcement learning, due to the short-term generated power amount increasing, the command value “0” indicating the speed-suppression mode may be judged to be the desirable control input and thus, in some cases, a good performance controller cannot be learned. Further, in the conventional reinforcement learning, at the initial step, as a result of the command value “0” indicating the speed-suppression mode being judged to be the desirable control input, the command value “0” indicating the speed-suppression mode may be primarily given to the wind-power power generation system 601. Therefore, in the conventional reinforcement learning, it is difficult to increase the rotational speed and learning a state in which the operating point of the windmill 610 is on the right side of the mountain-shape becomes impossible.

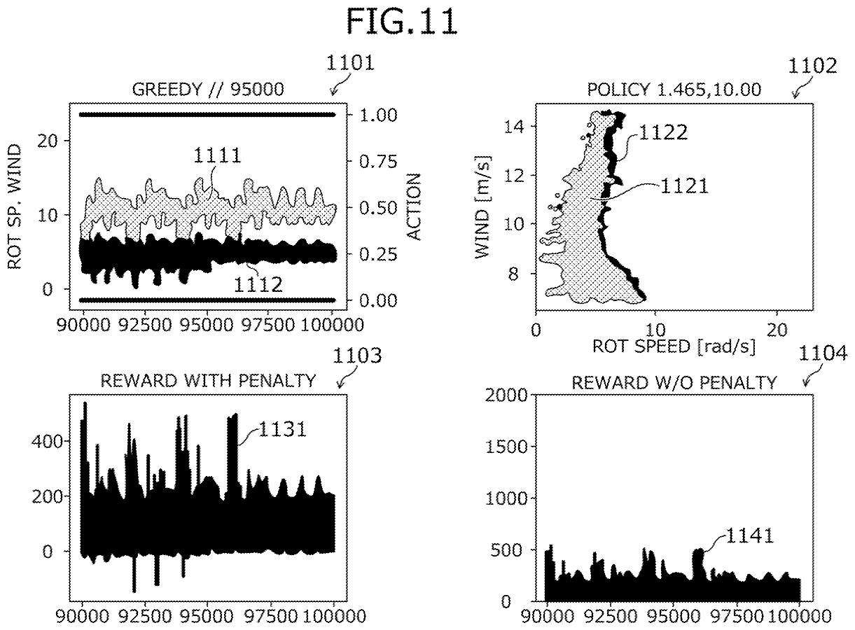

In contrast, with reference to FIGS. 11 to 13, results obtained by the reinforcement learning apparatus 100 in a case in which the reinforcement learning apparatus 100 applies the reinforcement learning to controlling the wind-power power generation system 601 will be described in comparison to the conventional reinforcement learning.

FIGS. 11, 12, and 13 are diagrams depicting results obtained by the reinforcement learning apparatus 100. Graphs 1101 to 1104 in FIG. 11 correspond to the conventional reinforcement learning. In the graph 1101, a horizontal axis is time. In the graph 1101, a plot 1111 is wind speed, In the graph 1101, a plot 1112 is rotational speed.

In the graph 1102, a horizontal axis is rotational speed. In the graph 1102, a vertical axis is wind speed. In the graph 1102, a plot 1121 is a plot of points indicating combinations of rotational speed and wind speed in the efficiency-oriented mode. In the graph 1102, a plot 1122 is a plot of points indicating combinations of rotational speed and wind speed in the speed suppression mode.

In the graph 1103, a horizontal axis is time. In the graph 1103, a vertical axis is reward. In the graph 1103, a plot 1131 is reward with a penalty when the windmill 610 stops. In the graph 1104, a horizontal axis is time. In the graph 1104, a vertical axis is reward, In the graph 1104, a plot 1141 is reward without a penalty when the windmill 610 stops.

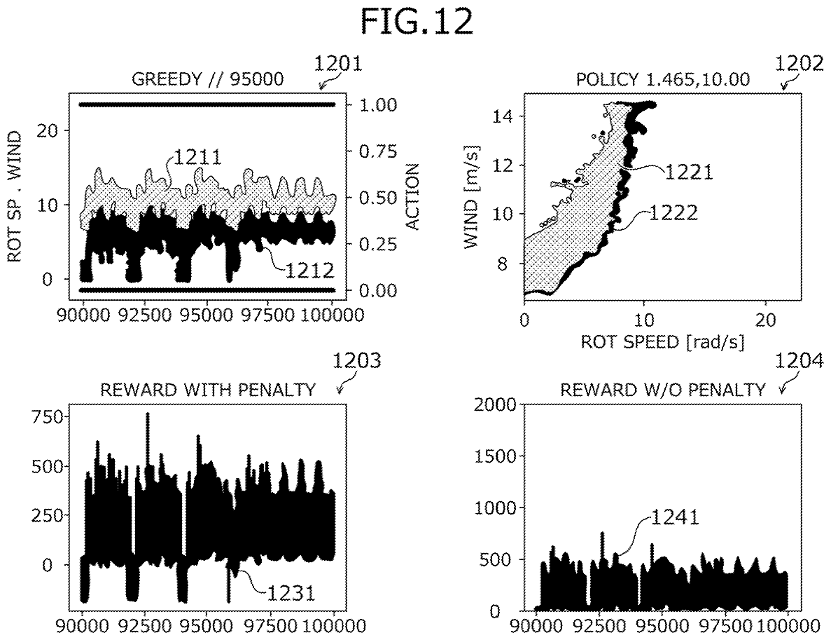

As depicted in the graphs 1101 and 1102, in the conventional reinforcement learning, the rotational speed remains relatively low and learning a state in which the operating point of the windmill 610 is on the right side of the mountain-shape is impossible. Further, as depicted in graphs 1103 and 1104, in the conventional reinforcement learning, the reward also remains relatively small. Next, FIG. 12 will be described,

In FIG. 12, graphs 1201 to 1204 correspond to reinforcement learning by the reinforcement learning apparatus 100 when k=3 is set, In the graph 1201, a horizontal axis is time. In the graph 1201, a plot 1211 is wind speed. In the graph 1201, a plot 1212 is rotational speed.

In the graph 1202, a horizontal axis is rotational speed. In the graph 1202, a vertical axis is wind speed. In the graph 1202, a plot 1221 is a plot of points indicating combinations of rotational speed and wind speed in the speed efficiency-oriented mode. In the graph 1202, a plot 1222 is a plot of points indicating combinations of rotational speed and wind speed in the speed-suppression mode.

In the graph 1203, a horizontal axis is time. In the graph 1203, a vertical axis is reward. In the graph 1203, a plot 1231 is reward with a penalty when the windmill 610 stops. In the graph 1204, a horizontal axis is time. In the graph 1204, a vertical axis is reward. In the graph 1204, a plot 1241 is reward without a penalty when the windmill 610 stops.

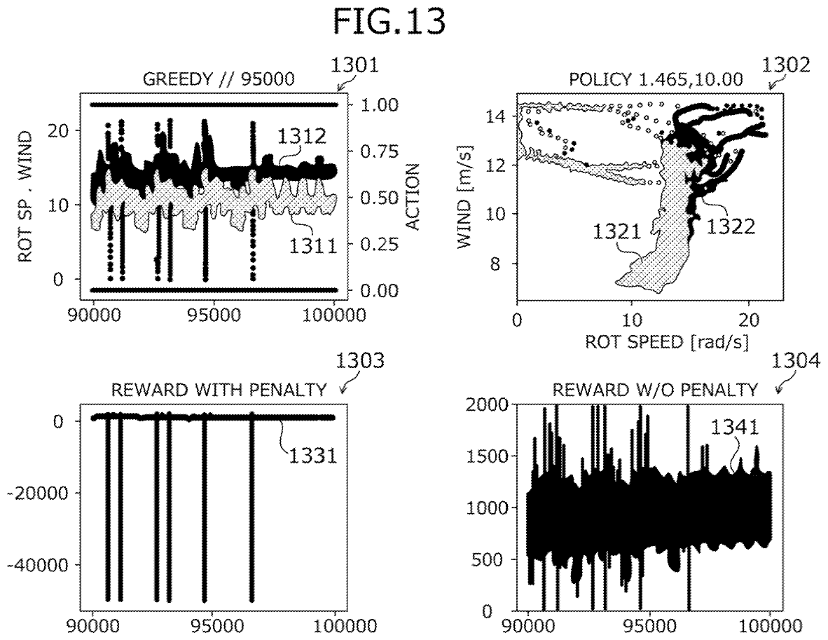

As depicted in the graphs 1201 and 1202, as compared to the conventional reinforcement learning, the reinforcement learning apparatus 100 may relatively increase the rotational speed and easily learn a state in which the operating point of the windmill 610 is on the right side of the mountain-shape. Further, as depicted in the graphs 1203 and 1204, as compared to the conventional reinforcement learning, the reinforcement learning apparatus 100 may relatively increase the reward as well. Thus, the reinforcement learning apparatus 100 enables a good performance controller to be learned, Next, FIG. 13 will, be described.

In FIG. 13, graphs 1301 to 1304 correspond to reinforcement learning by the reinforcement learning apparatus 100 when k=5 is set. In the graph 1301, a horizontal axis is time. In the graph 1301, a plot 1311 is wind speed. In the graph 1301, a plot 1312 is rotational speed.

In the graph 1302, a horizontal axis is rotational speed. In the graph 1302, a vertical axis is wind speed. In the graph 1302, a plot 1321 is a plot of points indicating combinations of rotational speed and wind speed in the efficiency-oriented mode. In the graph 1302, a plot 1322 is a plot of points indicating combinations of rotational speed and wind speed in the speed-suppression mode.

In the graph 1303, a horizontal axis is time. In the graph 1303, a vertical axis is reward. In the graph 1303, a plot 1331 is reward with a penalty when the windmill 610 stops. In the graph 1304, a horizontal axis is time. In the graph 1304, a vertical axis is reward. In the graph 1304, a plot 1341 is reward without a penalty when the windmill 610 stops.

As depicted in the graphs 1301 and 1302, as compared to the case in which k=3 is set, the reinforcement learning apparatus 100 may further increase the rotational speed and learn a state in which the operating point of the windmill 610 is on the right side of the mountain-shape. Further, as depicted in the graphs 1303 and 1304, as compared to the case in which k=3 is set, the reinforcement learning apparatus 100 may further increase reward. Thus, the reinforcement learning apparatus 100 enables a good performance controller to be learned.

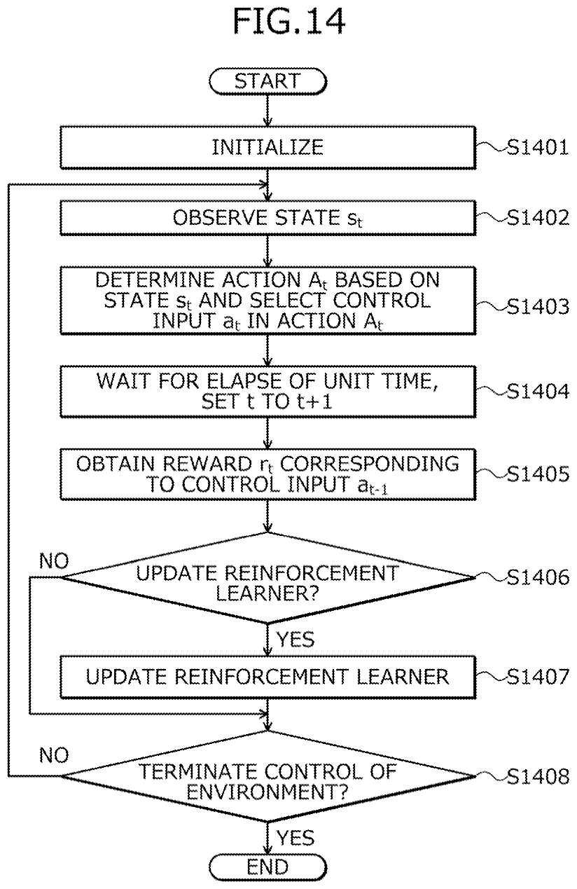

An example of a procedure of a reinforcement learning process executed by the reinforcement learning apparatus 100 will be described using FIG. 14. The reinforcement learning process, for example, is realized by the CPU 201, a storage area such as that of the memory 202, the recording medium 205, etc., and the network I/F 203 depicted in FIG. 2.

FIG. 14 is a flowchart of an example of a procedure of the reinforcement learning process. In FIG. 14, the reinforcement learning apparatus 100 initializes a variable t, the reinforcement learner Tr, and the history table 300 (step S1401).

Next, the reinforcement learning apparatus 100 observes the state sₜ and stores the state sₜ, using the history table 300 (step S1402). Subsequently, the reinforcement learning apparatus 100 determines the action. Aₜ based on the state sₜ and selects the control input aₜ in the action Aₜ and stores the control input aₜ, using the history table 300 (step S1403).

Next, the reinforcement learning apparatus 100 waits for the elapse of the unit time and sets t to t+1 (step S1404). Subsequently, the reinforcement learning apparatus 100 obtains the reward rₜ corresponding to the control input aₜ₋₁ and stores the reward rₜ, using the history table 300 (step S1405).

Next, the reinforcement learning apparatus 100 decides whether to update the reinforcement learner π (step S1406). Updating, for example, in the case of Q learning, is performed when control input and reward data of k groups has been accumulated. Therefore, updating, is performed whenever control input and reward data is newly obtained after the control input and reward data of k groups has been accumulated. Updating, for example, in the case of SARSA, is performed when control input and reward data of 2k groups has been accumulated.

Here, when updating is not to be performed (step S1406: NO), the reinforcement learning apparatus 100 transitions to a process at step S1408. On the other hand, when updating is to be performed (step S1406: YES), the reinforcement learning apparatus 100 transitions to a process at step S1407.

At step S1407, the reinforcement learning apparatus 100 refers to the history table 300 and updates the reinforcement learner π (step S1407). Subsequently, the reinforcement learning apparatus 100 transitions to a process at step S1408.

At step S1408, the reinforcement learning apparatus 100 decides whether to terminate control of the environment 110 (step S1408). Here, when control of the environment 110 is not to be terminated (step S1408: NO), the reinforcement learning apparatus 100 returns to the process at step S1402. On the other hand, when the control of the environment 110 is to be terminated (step S1408: YES), the reinforcement learning apparatus 100 terminates the reinforcement learning process.

In the example depicted in FIG. 14, while a case in which the reinforcement learning apparatus 100 executes the reinforcement learning process in a batch processing format, without limitation hereto, for example, the reinforcement learning apparatus 100 may execute the reinforcement learning process in a sequential processing format.

As described above, according to the reinforcement learning apparatus 100, a series of control inputs to the environment 110 including control inputs plural steps ahead may be defined as an action in the reinforcement learning. According to the reinforcement learning apparatus 100, the reinforcement learning may be implemented based on a series of control inputs to the environment 110 including control inputs plural steps ahead and a series of rewards from the environment 110 in response to the series of control inputs to the environment 110 including the control inputs plural steps ahead. Thus, the reinforcement learning apparatus 100 may enhance the efficiency of learning by reinforcement learning.

According to the reinforcement learning apparatus 100, the operating point of a windmill related to wind power generation may be controlled by the reinforcement learning. Thus, the reinforcement learning apparatus 100 may enhance the efficiency of learning by reinforcement learning even for the specific environment 110 that is related to wind-power power generation and that exhibits a nature of increasing short-term reward from the environment 110 and decreasing long-term reward by an action to the environment 110.

According to the reinforcement learning apparatus 100, a formula that expresses an action value function that prescribes the value of an action may be used. Thus, the reinforcement learning apparatus 100 may realize function-approximation-type reinforcement learning that uses a formula expressing an action value function that prescribes the value of an action.

According to the reinforcement learning apparatus 100, a table that prescribes the value of an action may be used. Thus, the reinforcement learning apparatus 100 may realize table-type reinforcement learning that uses a table prescribing the value of an action.

According to the reinforcement learning apparatus 100, for each step, a series of control inputs to the environment 110 including control inputs plural steps ahead may be determined, the first control input of the determined series of control inputs may be given to the environment 110, and a reward from the environment 110 in response to the first control input may be obtained. According to the reinforcement learning apparatus 100, the controller that controls the environment 110 may be updated based on the series of control inputs for plural steps actually given to the environment 110 and a series of rewards obtained in response the series of control inputs for the plural steps. Thus, the reinforcement learning apparatus 100 may efficiently update the controller.

According to the reinforcement learning apparatus 100, Q learning may be used. Thus, the reinforcement learning apparatus 100 may realize reinforcement learning that utilizes Q learning.

The reinforcement learning method described in the present embodiment may be implemented by executing a prepared program on a computer such as a personal computer and a workstation. A reinforcement learning program described in the present embodiments is stored on a non-transitory, computer-readable recording medium such as a hard disk, a flexible disk, a CD-ROM, an MO, and a DVD, read out from the computer-readable medium, and executed by the computer. The reinforcement learning program described in the present embodiments may be distributed through a network such as the Internet.

According to one aspect, it becomes possible to enhance the efficiency of learning by reinforcement learning.

All examples and conditional language provided herein are intended for pedagogical purposes of aiding the reader in understanding the invention and the concepts contributed by the inventor to further the art, and are not to be construed as limitations to such specifically recited examples and conditions. nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A reinforcement learning method, executed by a computer, for wind power generator control, the reinforcement learning method comprising:
obtaining, as an action for one step in a reinforcement learning, a series of control inputs to a windmill including control inputs for plural steps ahead;
obtaining, as a reward for one step in the reinforcement learning, a series of generated power amounts including generated power amounts for the plural steps ahead and indicating power generated by a wind power generator in response to rotations of the windmill; and
implementing reinforcement learning for each step of determining a control input to be given to the windmill based on the series of control inputs and the series of generated power amounts.

2. The reinforcement learning method according to claim 1, wherein the reinforcement learning is implemented using a formula that expresses an action value function prescribing a value of the action.

3. The reinforcement learning method according to claim 1, wherein the reinforcement learning is implemented using a table prescribing a value of the action.

4. The reinforcement learning method according to claim 1, wherein the reinforcement learning is a policy gradient type.

5. The reinforcement learning method according to claim 1, further comprising:
for each step, determining the series of control inputs to the windmill including the control inputs for the plural steps ahead;
giving a first control input of the determined series of control inputs to the windmill;
obtaining a generated power amount from the wind power generator in response to the first control input; and
updating a controller that controls the windmill, the controller being updated based on a series of the first control inputs actually given to the windmill for plural steps and the series of generated power amounts for the plural steps obtained in response to the series of the first control inputs actually given to the windmill for the plural steps.

6. The reinforcement learning method according to claim , wherein the reinforcement learning utilizes C learning.

7. A computer-readable recording medium storing therein a reinforcement learning program that is for wind power generator control and that causes a computer to execute a process, the process comprising:
obtaining, as an action for one step in a reinforcement learning, a series of control'inputs to a windmill including control inputs for plural steps ahead;
obtaining, as a reward for one step in the reinforcement learning. a series of generated power amounts including generated power amounts for the plural steps ahead and indicating power generated by a wind power generator in response to rotations of the windmill; and
implementing reinforcement learning for each step of determining a control input to be given to the windmill based on the series of control inputs and the series of generated power amounts.

8. A reinforcement learning apparatus for wind power generator control, the reinforcement learning apparatus comprising:
a memory; and
a processor coupled to the memory, the processor configured to:
obtain, as an action for one step in a reinforcement learning, a series of control inputs to a windmill including control inputs for plural steps ahead;
obtain, as a reward for one step in the reinforcement learning, a series of generated power amounts including generated power amounts for the plural steps ahead and indicating power generated by a wind power generator in response to rotations of the windmill; and
implement reinforcement learning for each step of determining a control input to be given to the windmill based on the series of control inputs and the series of generated power amounts.
